(19) United States
(12) Patent Application Publication
(10) Pub. No.: US 2017/0232855 A1
(43) Pub. Date: Aug. 17, 2017

(54) HIGH VOLTAGE BATTERY CHARGER AND METHODS OF OPERATION

(71) Applicant: GM GLOBAL TECHNOLOGY OPERATIONS LLC, Detroit, MI (US)

(72) Inventors: Joshua A. Vallender, Farmington, MI (US); Robert M. Rotay, Hartland, MI (US); Keith A. Kumar, Bailieboro (CA); Michael A. Assenmacher, Highland, MI (US)

(73) Assignee: GM GLOBAL TECHNOLOGY OPERATIONS LLC, Detroit, MI (US)

(21) Appl. No.: 15/041,681

(22) Filed: Feb. 11, 2016

(51) Int. Cl. B60L 11/18

(52) U.S. Cl. CPC B60L 11/1816; B60L 11/1838; B60L 11/1861

(57) ABSTRACT

A high voltage battery charger converts an AC input into a DC output. A controller is configured to calculate an efficiency of the high voltage battery charger, compare the calculated efficiency to a first threshold value, and signal a fault in response to the calculated efficiency being less than the first efficiency threshold value. Despite the fault, the battery charger keeps charging if the calculated efficiency and/or an average efficiency is not less than a second efficiency threshold value.

### TECHNICAL FIELD

The disclosure generally relates to a high voltage battery charger and methods for operating such a charger.

### BACKGROUND

Electric and hybrid electric vehicles include a renewable energy storage system (“RESS”), often referred to simply as a battery, for storing electrical energy. It is often desirable to charge the battery when the vehicle is not operating, e.g., in a garage or at a parking lot, with a battery charger. Unfortunately, when a fault in the battery charger is diagnosed, the charger may simply shut down, i.e., stop providing electrical power to the battery. As such, this may leave a driver of the vehicle with less charge than expected and/or desired.

### SUMMARY

In one exemplary embodiment, a method of operating a high voltage battery charger includes calculating an efficiency of the high voltage battery charger. The calculated efficiency is compared to a first threshold value. The method also includes signaling a fault in response to the calculated efficiency being less than the first efficiency threshold value. The method further includes comparing the calculated efficiency to a second efficiency threshold value. Charging is prevented in response to the calculated efficiency being less than the second efficiency threshold value.

In another exemplary embodiment, a method of operating a high voltage battery charger includes calculating an efficiency of the high voltage battery charger. The calculated efficiency is compared to a first threshold value. The method also includes signaling a fault in response to the calculated efficiency being less than the first efficiency threshold value. The method further includes calculating an average efficiency of the high voltage battery charger based on a plurality of calculated efficiencies. The average efficiency is compared to a second efficiency threshold value. The method also includes preventing charging in response to the average efficiency being less than the second efficiency threshold value.

In an exemplary embodiment, a high voltage battery charger includes at least one input terminal for receiving at least one alternating current (“AC”) input. The high voltage battery charger also includes at least one power converter electrically connected to the at least one input terminal for converting the AC input to a direct current (“DC”) output. The high voltage battery charger further includes at least one output terminal electrically connected to the at least one power converter for receiving the DC output. A controller is in communication with the at least one power converter. The controller is configured to calculate an efficiency of the high voltage battery charger, compare the calculated efficiency to a first threshold value, signal a fault in response to the calculated efficiency being less than the first efficiency threshold value, calculate an average efficiency of the high voltage battery charger based on a plurality of calculated efficiencies, and compare the average efficiency to a second efficiency threshold value. The controller is also configured to prevent DC output from being delivered to the at least one output terminal in response to the average efficiency being less than the second efficiency threshold value.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a block electric schematic diagram of a high voltage battery charger according to one exemplary embodiment;

FIG. 2 is a flowchart showing a method of operating the high voltage battery charger according to one exemplary embodiment; and

FIG. 3 is a flowchart showing a method of operating the high voltage battery charger according to another exemplary embodiment.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Referring to the Figures, wherein like numerals indicate like parts throughout the several views, a high voltage battery charger 100 and method 200 of operating are shown and described herein.

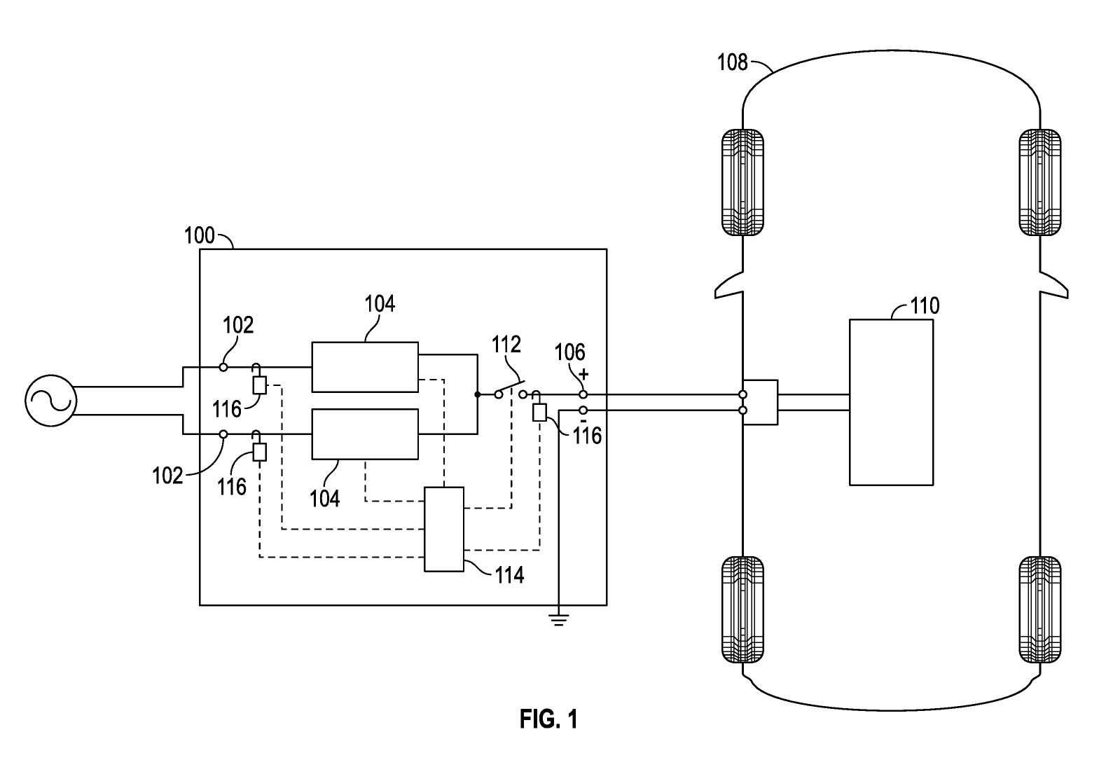

Referring to FIG. 1, the high voltage battery charger 100 includes at least one input terminal 102. The at least one input terminal 102 is configured to receive electrical power having an alternating current (“AC”). The AC power may be supplied, for example, by an electric utility company, a stand-alone generator, or other source. In the exemplary embodiment, the at least one input terminal 102 is implemented as a pair of input terminals 102, wherein each input terminal 102 is configured to receive different phases of AC power. However, it should be appreciated that the high voltage battery charger may be configured to receive one or three phases of AC power.

The high voltage battery charger 100 includes at least one power converter 104. The at least one power converter 104 is electrically connected to the at least one input terminal 102. The at least one power converter 104 is configured to convert the AC power to direct current (“DC”) power. The at least one power converter 104 may include various electrical and/or electronic circuits, e.g., inverters (not shown), to convert the AC power to DC power, as is readily appreciated by those skilled in the art.

The high voltage battery charger 100 further includes at least one output terminal 106 electrically connected to the at least one power converter 104. In the exemplary embodiment, a vehicle 108 may be electrically connected to the at least one power converter 104 such that the DC power supplied by the at least one power converter 104 may be transferred to the vehicle 108. More specifically, in the exemplary embodiment, the vehicle 108 includes a battery 110 electrically connected to the at least one output terminal 106.

The high voltage battery charger 100 may further include a switch 112 electrically connected between the at least one power converter 104 and the at least one output terminal 106. The switch 112 may selectively open and/or close, thus preventing and/or allowing DC power to flow between the at least one power converter 104 and the at least one output terminal 106. The switch 112 may be mechanically actuated, e.g., a contactor or relay, or may be a solid-state device, e.g., a power transistor. Those skilled in the art appreciate numerous techniques for implementing the switch 112.

The high voltage battery charger 100 also includes a controller 114. The controller 114 may include a processor (not shown) and a memory (not shown). The processor is capable of executing instructions, performing calculations, and/or otherwise manipulating data as is readily appreciated by those skilled in the art. The memory is capable of storing data. The processor and memory may be separate components or integrated together as is also appreciated by those skilled in the art. Furthermore, the processor and/or memory may be disposed outside the physical constraints of the high voltage battery charger 100. For example, the processor and/or memory may be disposed remotely, e.g., “cloud computing”.

The controller 114 may be in communication with the at least one power converter 104. As such, data may be transmitted from the at least one power converter 104 to the controller 114. Furthermore, the controller 114 may control aspects of the at least one power converter 104. The controller 114 may also be in communication with the switch 112. As such, the controller 114 may control operation of the switch 112, thus controlling whether or not DC power is flowing from the at least one power converter 104 to the output terminals 106.

The high voltage battery charger 100 may include one or more sensors 116 for sensing electrical characteristics. For example, the one or more sensors 116 may sense current, voltage, and/or power flowing through input terminals 102 and/or the outlet terminals 106.

The controller 114 of the exemplary embodiment is configured to perform the steps of the methods 200 described below. However, it should be appreciated that other computer and/or hardware configurations may be utilized to implement the methods 200.

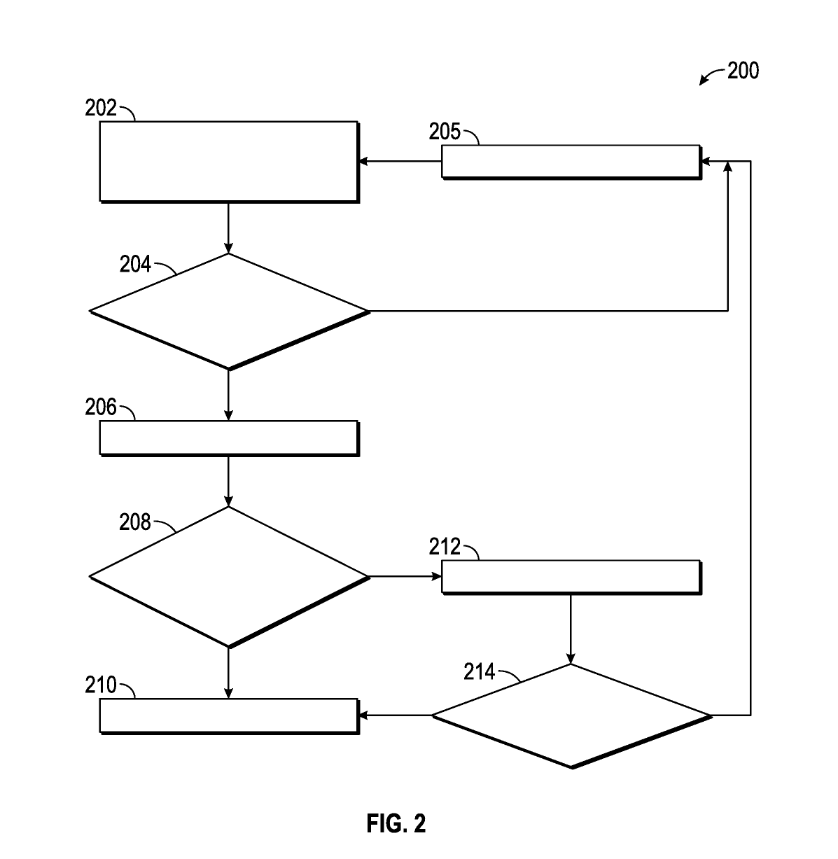

Referring now to FIG. 2, the method 200 includes, at 202, calculating an efficiency of the high voltage battery charger 100. Efficiency may be determined by dividing the output power of the high voltage battery charger 100 by the input power. In one embodiment, the output power and input power may be obtained by the one or more sensors 116. In another embodiment, the output power and/or input power may be estimated by the controller 114. For instance, the output power and/or input power may be estimated using data from the vehicle 108 and/or the battery 110, look-up tables, temperature, known resistance, and/or other factors appreciated by those skilled in the art.

The method 200 further includes, at 204, comparing the calculated efficiency to a first threshold efficiency value. In one exemplary embodiment, the first efficiency threshold value is about 67%, i.e., 0.67. Of course, the first efficiency threshold value may be set to other values as appreciated by those skilled in the art.

If the calculated efficiency is greater than or equal to the first threshold value, then no particular action is taken by the method 200. That is, the high voltage battery charger 100 operates normally by converting AC power to DC power that is provided to the output terminals 106. Said simply, the high voltage battery charger continues charging, as shown at 205. The steps 202, 204 of calculating the efficiency of the high voltage battery charger 100 and comparing the calculated efficiency to the first threshold efficiency value may be repeated. That is, the high voltage battery charger 100 may be continuously monitored to ensure that the efficiency remains at or above the first efficiency threshold value. Calculating the efficiency of the high voltage battery charger 100, i.e., step 202, may also be performed at other times as appreciated by those skilled in the art.

If the calculated efficiency is less than the first efficiency threshold value, then the method 200 continues, at 206, with signaling a fault. In one embodiment, the high voltage battery charger 100 may send an error signal to the vehicle 108. The vehicle 108, in receipt of the fault signal, may then set a diagnostic trouble code (“DTC”) and/or illuminate a malfunction indicator lamp (“MIL”) as is appreciated by those skilled in the art. The vehicle 108 may also display the fault on a display screen (not shown) as is also appreciated by those skilled in the art. Furthermore, the high voltage battery charger 100 may include an indicator light (not shown) and/or a display screen (not shown) for signaling the fault.

In one embodiment, the method 200 includes, at 208, comparing the calculated efficiency to a second efficiency threshold value. In the exemplary embodiments, the second efficiency threshold value is less than the first efficiency threshold value. In one exemplary embodiment, the second first efficiency threshold value is about 20%, i.e., 0.2. Of course, the second efficiency threshold value may be set to other values as appreciated by those skilled in the art.

If the calculated efficiency is less than the second efficiency threshold value, then the method 200 continues, at 210, with preventing charging by the high voltage battery charger 100. That is, in response to the calculated efficiency being less than the second efficiency threshold value, then DC power is prevented from being supplied through the output terminals 106. For example, the switch 112 may be opened to isolate the output terminals 106 from the at least one power converter 104.

If the calculated efficiency is greater than or equal to the second efficiency threshold value, then the high voltage battery charger 100 will continue to provide DC output power to charge, e.g., the battery 110. As such, even when efficiency falls below the first efficiency threshold, indicating a problem with the high voltage battery charger 100, the charger 100 continues to provide DC output power so long as the efficiency is greater than or equal to the second efficiency threshold value. Said another way, The high voltage battery charger 100 provides output power in response to the calculated efficiency being greater than or equal to the first efficiency threshold value and the second efficiency threshold value. Therefore, the vehicle 108 may be charged even though a problem may have arisen with the high voltage battery charger 100.

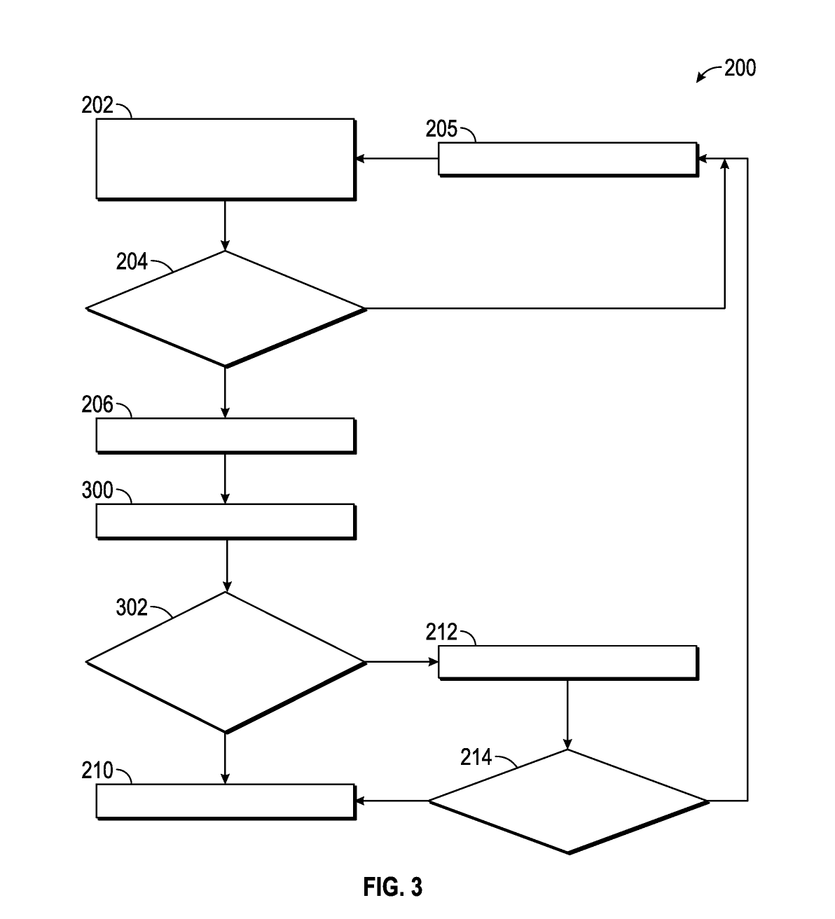

In another embodiment, as shown in FIG. 3, the method 200 includes, at 300, calculating an average efficiency of the high voltage battery charger 100 based on a plurality of calculated efficiencies. As stated above, the efficiency may be calculated multiple times in the periodic diagnostic checking of the high voltage battery charger 100. In this embodiment, a plurality of efficiency calculations are summed together. Then, an average efficiency is calculated by dividing the summed plurality of efficiency calculations by the number of efficiency calculations.

Still referring to FIG. 3, the method 200 of this embodiment includes, at 302, comparing the average efficiency to the second efficiency threshold value. If the average efficiency is less than the second efficiency threshold value, then the method 200 continues, at 210, with preventing charging by the high voltage battery charger 100. That is, in response to the average efficiency being less than the second efficiency threshold value, then DC power is prevented from reaching the output terminals 106. For example, the switch 112 may be opened to isolate the output terminals 106 from the at least one power converter 104.

By utilizing the average efficiency, the method 200 shown in FIG. 3 advantageously does not shut down DC power to the output terminals 106 in case there is merely a momentary change in the efficiency calculation.

Referring now to FIG. 2 or 3, the method 200 may further include, at 212, determining an output power of the high voltage battery charger 100. In one embodiment, determining the output power may be accomplished utilizing a sensor 116 disposed adjacent to the output terminals 106. The method 200 may also include, at 214, comparing the output power to a threshold power value. In the exemplary embodiments, the threshold power value is the minimum amount of DC power needed to provide a charge to the battery 110. As such, the threshold power value may be dependent on the particular electrical characteristics and/or configuration of the battery 110 and the vehicle 108.

If the output power is less than the threshold power value, then the method 200 continues, at 210, with preventing charging by the high voltage battery charger 100. That is, in response to the DC output power being less than the threshold power value, then the DC power is prevented from reaching the output terminals 106. For example, the switch 112 may be opened to isolate the output terminals 106 from the at least one power converter 104.

By monitoring the output power, in addition to the efficiency, the method 200 utilizes another technique to determine whether or not the high voltage battery charger 100 is capable of supplying sufficient DC power to the battery 110 of the vehicle 108 to progressively charge the battery 110.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A method of operating a high voltage battery charger, comprising:
calculating an efficiency of the high voltage battery charger;
comparing the calculated efficiency to a first threshold value;
signaling a fault in response to the calculated efficiency being less than the first efficiency threshold value;
comparing the calculated efficiency to a second efficiency threshold value; and
preventing charging in response to the calculated efficiency being less than the second efficiency threshold value.

2. The method as set forth in claim 1 further comprising determining an output power of the high voltage battery charger.

3. The method as set forth in claim 2 further comprising comparing the output power to a threshold power value.

4. The method as set forth in claim 3 further comprising preventing charging in response to the output power being less than the threshold power value.

5. The method as set forth in claim 2 further comprising determining an input power of the high voltage battery charger.

6. The method as set forth in claim 5 wherein calculating an efficiency comprises dividing the output power by the input power.

7. The method as set forth in claim 1 wherein the second efficiency threshold value is less than the first efficiency threshold value.

8. The method as set forth in claim 1 further comprising calculating an average efficiency of the high voltage battery charger based on a plurality of calculated efficiencies.

9. The method as set forth in claim 8 further comprising preventing charging in response to the average efficiency being less than the second efficiency threshold value.

10. The method as set forth in claim 1 further comprising:
receiving at least one alternating current (“AC”) input; and
converting the at least one AC input into at least one direct current (“DC”) output; and wherein
preventing charging comprises preventing the at least one DC output from being supplied to at least one output terminal.

11. The method as set forth in claim 1 wherein calculating an efficiency of the high voltage battery charger comprises:
estimating an output power of the high voltage battery charger;
estimating an input power of the high voltage battery charger; and
dividing the estimated output power by the estimated input power to derive the efficiency of the high voltage battery charger.

12. The method as set forth in claim 1 further comprising providing output power in response to the calculated efficiency being greater than or equal to the first efficiency threshold value and the second efficiency threshold value.

13. A method of operating a high voltage battery charger, comprising:
calculating an efficiency of the high voltage battery charger;
comparing the calculated efficiency to a first threshold value;
signaling a fault in response to the calculated efficiency being less than the first efficiency threshold value;
calculating an average efficiency of the high voltage battery charger based on a plurality of calculated efficiencies;
comparing the average efficiency to a second efficiency threshold value; and
preventing charging in response to the average efficiency being less than the second efficiency threshold value.

14. The method as set forth in claim 13 further comprising determining an output power of the high voltage battery charger.

15. The method as set forth in claim 14 further comprising comparing the output power to a threshold power value.

16. The method as set forth in claim 15 further comprising preventing charging in response to the output power being less than the threshold power value.

17. A high voltage battery charger comprising:
at least one input terminal for receiving at least one alternating current (“AC”) input;
at least one power converter electrically connected to the at least one input terminal for converting the AC input to a direct current (“DC”) output;
at least one output terminal electrically connected to the at least one power converter for receiving the DC output;
a controller in communication with the at least one power converter and configured to:
calculate an efficiency of the high voltage battery charger;
compare the calculated efficiency to a first threshold value;
signal a fault in response to the calculated efficiency being less than the first efficiency threshold value;
calculate an average efficiency of the high voltage battery charger based on a plurality of calculated efficiencies;
compare the average efficiency to a second efficiency threshold value; and
prevent DC output from being delivered to the at least one output terminal in response to the average efficiency being less than the second efficiency threshold value.

18. The high voltage battery charger as set forth in claim 17 wherein the controller is further configured to determine an output power being delivered to the at least one output terminal.

19. The high voltage battery charger as set forth in claim 18 wherein the controller is further configured to compare the output power to a threshold power value.

20. The high voltage battery charger as set forth in claim 18 wherein the controller is further configured to prevent DC output from being delivered to the at least one output terminal in response to the output power being less than the threshold power value.
